(19) United States
(12) Patent Application Publication
(10) Pub. No.: US 2014/0253398 A1
(43) Pub. Date: Sep. 11, 2014

(54) TUNABLE ANTENNA

(71) Applicant: ASUSTeK COMPUTER INC., TAIPEI (TW)

(72) Inventors: Tsung-Hsun HSIEH, TAIPEI (TW); Ting-Yi LIN, TAIPEI (TW); Yeh-Chun KAO, TAIPEI (TW); Yu-Chia CHANG, TAIPEI (TW); You-Fu CHENG, TAIPEI (TW)

(73) Assignee: ASUSTeK COMPUTER INC., TAIPEI (TW)

(21) Appl. No.: 14/190,114

(22) Filed: Feb. 26, 2014

Related U.S. Application Data
(60) Provisional application No. 61/773,161, filed on Mar. 6, 2013.

(30) Foreign Application Priority Data
Dec. 25, 2013 (TW) 102148213

(51) Int. Cl. H01Q 9/14

(52) U.S. Cl. CPC H01Q 9/145
USPC 343/745

(57) ABSTRACT

A tunable antenna includes a ground plane, a first radiation unit and a second radiation unit. The first radiation unit includes a feeding portion and a coupling portion. The feeding portion is electrically connected to a signal source. The second radiation unit surrounds a part of the coupling portion and includes a grounding end and a switch unit. The grounding end is electrically connected to the ground plane. The switch unit is electrically connected to the grounding end and the ground plane selectively.

### CROSS-REFERENCE TO RELATED APPLICATION

This application claims the priority benefits of U.S. provisional application Ser. No. 61/773,161, filed on Mar. 6, 2013 and Taiwan application serial No. 102148213, filed on Dec. 25, 2013. The entirety of the above-mentioned patent applications are hereby incorporated by references herein and made a part of specification.

### BACKGROUND OF THE INVENTION

1. Field of the Invention

The invention relates to a tunable antenna.

2. Description of the Related Art

Recently, as communication technology develops, a wireless communication device is usually used for receiving or transmitting multiband radio signals. However, the wireless communication standards and communication bands are different around the world. The conventional wireless communication device usually designs a broadband antenna or a multiband antenna to receive and transmit radio signals of different bands, but antenna design in broadband antenna and multiband antenna are difficult and challenging. As the wireless communication device becomes thinner, the volume of the antenna inside is limited, and an appropriate broadband antenna becomes more difficult in design.

### BRIEF SUMMARY OF THE INVENTION

A tunable antenna disclosed herein includes a ground plane, a first radiation unit and a second radiation unit. The first radiation unit includes a feeding portion and a coupling portion, and the feeding portion is electrically connected to the signal source. The second radiation unit surrounds a part of the coupling portion, and includes a grounding end and a switch unit. The grounding end is electrically connected to the ground plane. The switch unit is electrically connected to the grounding end and the ground plane selectively.

Consequently, the electrical connecting area of the second radiation unit and the ground plane can be adjusted via the switch unit without changing the position of the grounding point, so as to switch a resonant band of the tunable antenna, which achieves the function of a multiband antenna in a limited volume.

These and other features, aspects and advantages of the present disclosure will become better understood with regard to the following description, appended claims, and accompanying drawings.

### BRIEF DESCRIPTION OF THE DRAWINGS

FIG. 1 is a schematic diagram showing a tunable antenna and a signal source in a first embodiment;

FIG. 2A is an equivalent diagram showing a switch unit of the tunable antenna in FIG. 1 in an off state;

FIG. 21 is an equivalent diagram showing a switch unit of the tunable antenna in FIG. 1 in an on state;

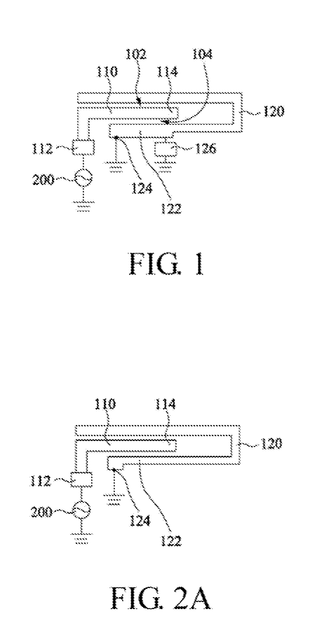

FIG. 3 is a coordinate graph showing a return loss of the tunable antenna in FIG. 1;

FIG. 4 is a schematic diagram showing a tunable antenna and a signal source in the second embodiment;

FIG. 5 is a schematic diagram showing a tunable antenna and a signal source in the third embodiment

FIG. 6 is a schematic diagram showing a tunable antenna and a signal source in the fourth embodiment;

FIG. 7 is a schematic diagram showing a tunable antenna and a signal source in the fifth embodiment;

FIG. 8 is a schematic diagram showing a tunable antenna and a signal source in the sixth embodiment;

FIG. 9 is a schematic diagram showing a tunable antenna and a signal source in the seventh embodiment; and

FIG. 10 is a schematic diagram showing a tunable antenna and a signal source in the eighth embodiment.

### DETAILED DESCRIPTION OF THE EMBODIMENTS

The disclosure is illustrated with relating embodiments in the following. The disclosure should not be limited by the details in the embodiments, which means in several embodiments, the details are not essential. Conventional structures and elements are simplified in the figures.

FIG. 1 is a schematic diagram showing a tunable antenna and a signal source 200 in a first embodiment. As shown in FIG. 1, the tunable antenna includes a ground plane, a first radiation unit 110 and a second radiation unit 120. The first radiation unit 110 includes a feeding portion 112 and a coupling portion 114, and the feeding portion 112 is electrically connected to a signal source 200. The second radiation unit 120 includes a grounding end 122 and a switch unit 126, and the second radiation unit 120 surrounds a part of the coupling portion 114 of the first radiation unit 110. The grounding end 122 is electrically connected to the ground plane. In FIG. 1, the grounding end 122 is electrically connected to the ground plane via a grounding point 124. The switch unit 126 is selectively connected to the grounding end 122 to adjust an electrical connecting area of the second radiation unit 120 and the ground plane, and resonant frequency of the tunable antenna can also be adjusted. The first switch element 126 can be diodes or varactors.

Signals from the signal source 200 can be transmitted via the feeding portion 112 of the first radiation unit 110 to generate a resonant mode at the first radiation unit 110. Moreover, other resonant modes can be generated via the electromagnetic coupling of the second radiation unit 120 and the first radiation unit 10. On the other hand, the switch unit 126 is controlled to change the electrical connecting area of the second radiation unit 120 and the ground plane, so as to change the resonant mode of the second radiation unit 120. Thus, the resonant band of the tunable antenna can be adjusted.

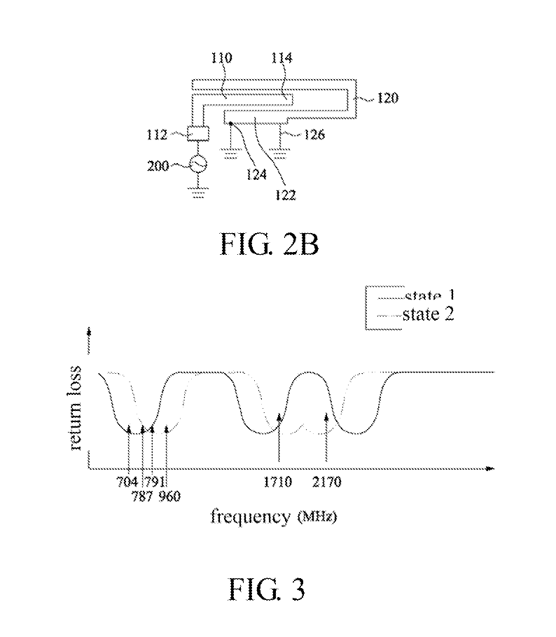

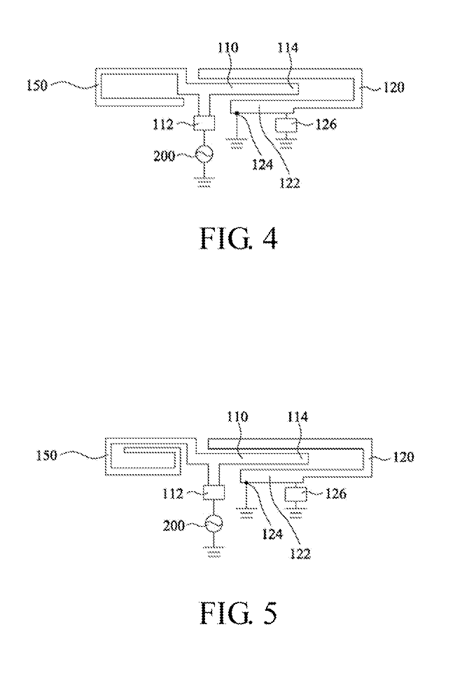

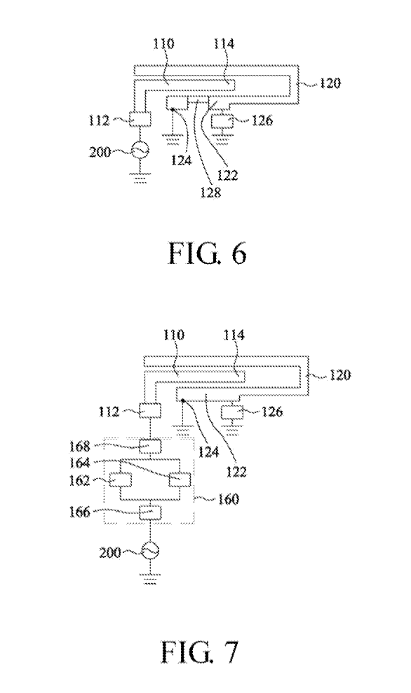

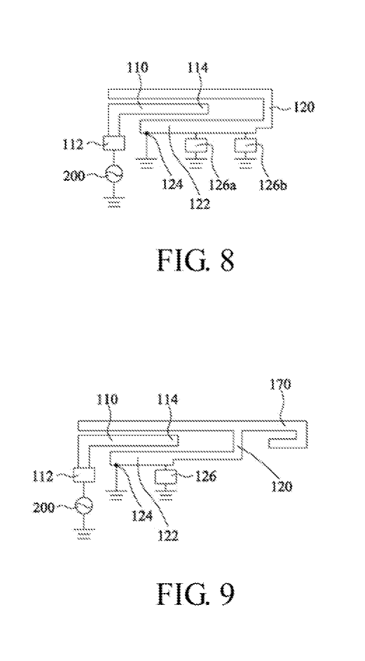

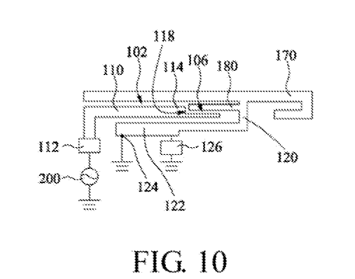

Please refer to FIG. 2A and FIG. 3, FIG. 2A is an equivalent diagram showing the switch unit 126 of the tunable antenna in FIG. 1 in an off state, and FIG. 3 is a coordinate graph showing a return loss of the tunable antenna in FIG. 1. When the switch unit 126 is at an off state (as shown in FIG. 1 and represented by “state 1” in FIG. 3), the resonant band of the second radiation unit 120 is about 704 to 787 MHz.

On the other hand, please refer to FIG. 2B and FIG. 3, FIG. 2B is an equivalent diagram showing the switch unit 126 of the tunable antenna in FIG. 1 in an on state. When the switch unit 126 is at an on state (which is represented by “state 2” in FIG. 3), the second radiation unit 120 is electrically connected to the ground plane via the switch unit 126. In FIG. 2B, the radiating path of the second radiation unit 120 is shorter than that in FIG. 2A, and thus the resonance band of the second radiation unit 120 can be increased to 791 to 960 MHz. On the other hand, another resonant band in the state 2 is about 1710 to 2170 MHz, and it is a combination of the second harmonic resonant band of the second radiation unit 120 and the resonant band of the first radiation unit 110.

Thus, the electrical connecting area of the second radiation unit 120 and the ground plane can be adjusted via the switch unit 126 without changing the position of the grounding point 124, so as to switch the resonant band of the tunable antenna and achieve a broadband antenna in a limited volume.

Please refer to FIG. 1 again, in the embodiment, the second radiation unit 120 and the coupling portion 114 of the first radiation unit 110 define a first coupling gap 102 and a second coupling gap 104. The first coupling gap 102 and the second coupling gap 104 are at two opposite sides of the coupling portion 114, respectively. The energy of the first radiation unit 110 can be coupled to the second radiation unit 120 via the first coupling gap 102 and the second coupling gap 104, and the second radiation unit 120 generates a resonant mode. The frequency range of the resonant mode generated by the second radiation unit 120 can be determined by the first coupling gap 102 and the second coupling gap 104. Taking the second coupling gap 104 as an example, when the second coupling gap 104 is small, which means the grounding end 122 of the second radiation unit 120 is close to the coupling portion 114 of the first radiation unit 110, a large coupling capacitance exists between the grounding end 122 and the coupling portion 114, and thus the resonant mode of the second radiation unit 120 can be changed. Similarly, the first coupling gap 102 can also affect the resonant mode of the second radiation unit 120. Consequently, the resonant mode of the second radiation unit 120 can be adjusted by changing the first coupling gap 102 and the second coupling gap 104.

FIG. 4 is a schematic diagram showing a tunable antenna and the signal source 200 in the second embodiment. The difference between the second embodiment and the first embodiment is that the tunable antenna further includes a third radiation unit 150. In the embodiment, the third radiation unit 150 is electrically connected to the first radiation unit 110. The third radiation unit 150 includes a meander portion to increase the current path of the tunable antenna. In detail, the third radiation unit 150 and the first radiation unit 110 may form a T shape.

In the embodiment, the third radiation unit 150 includes a meander portion, and thus the radiating path of the third radiation unit 150 is increased to generate a lower resonant frequency. As shown in FIG. 4, the radiating path of the first radiation unit 110 is shorter than that of the third radiation unit 150, and thus the resonant frequency of the first radiation unit 110 is higher than that of the third radiation unit 150. On the other hand, since the second radiation unit 120 and the ground plane form a short circuit, the radiating path of the second radiation unit 120 is about ¼ wave length of the resonant frequency. Other details are the same as those in the first embodiment, which is omitted.

FIG. 5 is a schematic diagram showing a tunable antenna and the signal source 200 in the third embodiment. The difference between the third embodiment and the second embodiment is the structure of the third radiation unit 150. In the embodiment, the meander portion of the third radiation unit 150 bends inwards in a spiral way. Thus, with the bent third radiation unit 150, the radiating path of the third radiation unit 150 is longer in the same configuration area, and a lower resonant frequency can be generated. Other details are the same as those in the second embodiment, which is omitted.

FIG. 6 is a schematic diagram showing a tunable antenna and the signal source 200 in the fourth embodiment. The difference between the fourth embodiment and the first embodiment is the structure of the grounding end 122. In the embodiment, the grounding end 122 includes a coupling element 128. The coupling element 128 is disposed between the grounding point 124 and the switch unit 126. In brief performance of the tunable antenna can be changed via the coupling element 128. For example, the coupling element 128 may be an inductor, and the inductor can increase the radiating path of the second radiation unit 120. That means, when the switch unit 126 is at an on state, the resonance band of the tunable antenna is the same as that in FIG. 2B. If the switch unit 126 is at an off state, the resonance band of the second radiation unit 120 is slightly shifted to the low frequencies compared with the state 1 shown in FIG. 2A. The coupling element 128 is not limited to an inductor. Other details are the same as those in the first embodiment, which is omitted.

FIG. 7 is a schematic diagram showing a tunable antenna and the signal source 200 in the fifth embodiment. The difference between the fifth embodiment and the first embodiment is a matching network 160. In the embodiment, the tunable antenna further includes a matching network 160 electrically connected to the first radiation unit 110 and the signal source 200. In detail, an impedance mismatch problem may exist between the signal source 200 and the tunable antenna, which results in a signal reflection when a signal is transmitted from the signal source 200 to the feeding portion 112 and brings energy loss. Thus, the matching network 160 may be disposed between the signal source 200 and the feeding portion 112 to avoid the impedance mismatch.

In the embodiment, the matching network 160 may include a first matching circuit 162, a second matching circuit 164, a first switch element 166 and a second switch element 168. The first switch element 166 is electrically connected to the signal source 200 and is connected to the first matching circuit 162 or the second matching circuit 164 selectively. The second switch element 168 is electrically connected to the first radiation unit 110 and connected to the first matching circuit 162 or the second matching circuit 164 selectively. In detail, both the first matching circuit 162 and the second matching circuit 164 may be a combination of capacitors and inductors. The first matching circuit 162 and the second matching circuit 164 may have different matching impedances, and thus different signals can selectively pass through different matching circuits. For example, if the tunable antenna connected to the first matching circuit 162 has better performance, the first switch element 166 and the second switch element 168 can be electrically connected to the first matching circuit 162, and the signal from the signal source 200 passes through the first switch element 166, the first matching circuit 162 and the second switch element 168 in sequence and reaches the feeding portion 112. On the contrary, if the tunable antenna connected to the second matching circuit 164 has better performance, the first switch element 166 and the second switch element 168 may also be electrically connected to the second matching circuit 164. In the embodiment, the matching network 160 includes two matching circuits, which is not limited herein. The number of the matching circuits of the matching network 160 can be selected according to practical requirements. Other details are the same as those in the first embodiment, which is omitted.

FIG. 8 is a schematic diagram showing a tunable antenna and the signal source 200 in the sixth embodiment. The difference between the sixth embodiment and the first embodiment is the number of the switch units. In the embodiment there is a plurality of the switch units. As shown in FIG. 8, the tunable antenna includes two switch units 126a and 126b. When both the switch units 126a and 126b are at an off state, the second radiation unit 120 generates a lower resonant band. When the switch unit 126a is at an on state and the switch unit 126b is at an off state, the resonant band of the second radiation unit 120 is higher. When both the switch units 126a and 126b are at an on state, the resonant frequency of the second radiation unit 120 is further higher. Thus, the resonant band of the second radiation unit 120 can be adjusted by controlling the switch units 126a and 126b. In the embodiment, the tunable antenna includes two switch units 126a and 126b, which is not limited herein. The number of the switch units of the tunable antenna can be selected according to practical requirements. Other details are the same as those in the first embodiment, which is omitted.

FIG. 9 is a schematic diagram showing a tunable antenna and the signal source 200 in the seventh embodiment. The difference between the seventh embodiment and the first embodiment is a fourth radiation unit 170. In the embodiment, the tunable antenna further includes a fourth radiation unit 170 electrically connected to the second radiation unit 120. As shown in FIG. 9, a part of the second radiation unit 120 is between the fourth radiation unit 170 and the first radiation unit 110. In other words, the fourth radiation unit 170 is disposed relatively to the first radiation unit 110. When the second radiation unit 120 is electromagnetically coupled to the first radiation unit 110, the fourth radiation unit 170 electrically connected to the second radiation unit 120 can also generate a resonant mode. The resonant band of the fourth radiation unit 170 can be changed by adjusting the shape and length of the fourth radiation unit 170. The radiating path of the fourth radiation unit 170 is about ¼ wave length of the resonance frequency. The fourth radiation unit 170 can generate a resonance band 2500 to 2690 MHz. That is, the fourth radiation unit 170 can broaden the high bandwidth of the tunable antenna. Other details are the same as those in the first embodiment, which is omitted.

FIG. 10 is a schematic diagram showing a tunable antenna and the signal source 200 in the eighth embodiment. The difference between the eighth embodiment and the seventh embodiment is a fifth radiation unit 180. In the embodiment, the tunable antenna further includes a fifth radiation unit 180 electrically connected to the second radiation unit 120. When the second radiation unit 120 is electromagnetically coupled to the first radiation unit 110, the fifth radiation unit 180 can also generate another resonant mode. The resonant band of the fifth radiation unit 180 can be changed by adjusting the shape and length of the fourth radiation unit 180. The radiating path of the fifth radiation unit 180 is about ¼ wave length of the resonance frequency. The fifth radiation unit 180 can be used to adjust the impedance matching of the tunable antenna.

In detail, the coupling portion 114 of the first radiation unit 110 includes a concaved portion 118, and a part of the fifth radiation unit 180 is at the concaved portion 118 to form a third coupling gap 106 with the coupling portion 114. In other words, the concaved portion 118 is formed by changing width of the coupling portion 114. The width of a part of the coupling portion 114 between the fifth radiation unit 180 and a part of the second radiation unit 120 close to the grounding end 122 is smaller, and the width of other parts of the coupling portion 114 away from the fifth radiation unit 180 is larger. The third coupling gap 106 may be smaller than the first coupling gap 102, and thus the energy of the first radiation unit 110 can be effectively transmitted to the second radiation unit 120 via the fifth radiation unit 180. Other details are the same as those in the seventh embodiment, which is omitted.

Although the present disclosure has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A tunable antenna, comprising:
a ground plane;
a first radiation unit including a feeding portion and a coupling portion, the feeding portion is electrically connected to a signal source; and
a second radiation unit, surrounding a part of the coupling portion, and the second radiation unit includes:
a grounding end electrically connected to the ground plane; and
a switch unit electrically connected to the grounding end and the ground plane selectively.

2. The tunable antenna according to claim 1, wherein the tunable antenna further includes:
a third radiation unit, wherein the third radiation unit includes a meander portion, and is electrically connected to the first radiation unit.

3. The tunable antenna according to claim 1, wherein a first coupling gap and a second coupling gap exist between the second radiation unit and the coupling portion.

4. The tunable antenna according to claim 1, wherein the grounding end is electrically connected to the ground plane via a grounding point, the grounding end includes a coupling element, and the coupling element is disposed between the grounding point and the switch unit.

5. The tunable antenna according to claim 1, wherein the tunable antenna further includes:
a matching network electrically connected to the first radiation unit and the signal source.

6. The tunable antenna according to claim 5, wherein the matching network includes:
a first matching circuit;
a second matching circuit;
a first switch element electrically connected to the signal source, and selectively connected to the first matching circuit or the second matching circuit; and
a second switch element electrically connected to the first radiation unit, and selectively connected to the first matching circuit or the second matching circuit.

7. The tunable antenna according to claim 1, wherein the tunable antenna further includes:
a fourth radiation unit electrically connected to the second radiation unit.

8. The tunable antenna according to claim 7, wherein a part of the second radiation unit is disposed between the fourth radiation unit and the first radiation unit.

9. The tunable antenna according to claim 1, wherein the tunable antenna further includes:
a fifth radiation unit electrically connected to the second radiation unit, a first coupling gap exists between the second radiation unit and the coupling portion, the coupling portion of the first radiation unit includes a concaved portion, a part of the fifth radiation unit is at the concaved portion, a third coupling gap exists between the fifth radiation unit and the coupling portion, and the third coupling gap is smaller than the first coupling gap.
